(19) United States
(12) Patent Application Publication
(10) Pub. No.: US 2015/0299012 A1
(43) Pub. Date: Oct. 22, 2015

(54) Biodegradable Runoff Filter

(71) Applicants: Joseph Greco, Atlantic, PA (US); James A Elkin, Shelocta, PA (US); Perry R Burt, Cambridge, OH (US)

(72) Inventors: Joseph Greco, Atlantic, PA (US); James A Elkin, Shelocta, PA (US); Perry R Burt, Cambridge, OH (US)

(21) Appl. No.: 14/692,056

(22) Filed: Apr. 21, 2015

Related U.S. Application Data
(60) Provisional application No. 61/982,596, filed on Apr. 22, 2014.

(51) Int. Cl. C02F 3/32

(52) U.S. Cl. CPC C02F 3/327

(57) ABSTRACT

A biodegradable runoff filter is an apparatus that is used to filter silt, chemicals, and other contaminants out of water runoff produced at or near a work site. The apparatus includes a biodegradable filter sock, a botanical biomass filling, and a fastener. The biodegradable filter sock is a water-permeable container that is used to contain an amount of the botanical biomass filling. The biodegradable filter sock includes a lateral portion, an open end and a closed end. The lateral portion and the closed end surround the botanical biomass filling and contain it to a specific area. The open end of the biodegradable filter sock allows the botanical biomass filling to be packed into the biodegradable filter sock. The fastener fits over the open end and cinches the open end shut to prevent the botanical biomass filling from falling out of the biodegradable filter sock.

The current application claims a priority to the U.S. Provisional Patent application Ser. No. 61/982,596 filed on Apr. 22, 2014.

### FIELD OF THE INVENTION

The present invention relates generally to sediment filter apparatuses. More specifically, the present invention is a switch grass filled filter sock which is designed to provide sediment filtering capabilities. The present invention has several advantages over currently available sediment filtering apparatuses including, but not limited to, increased filtering effectiveness, reduced weight, increased ease of installation, ecological neutrality, and biodegradability.

### BACKGROUND OF THE INVENTION

In the modern world, the economy is driven largely in part by a massive industrial complex which is crucial to maintaining the current standards of living of a developed country. There are many different facets of modern industry encompassing many different processes which mine and refine raw materials, as well as manufacturing components, and constructing new buildings.

The mining of raw materials can be viewed as the starting point of the industrial complex, and typically involves the extraction of materials from the Earth. There are many different methods of mining, many of them being specialized for mining specific types of materials. Regardless of the method, the end result is similar, raw materials are extracted from within the earth, and are readied for transport to a facility where they can be refined into more purified and useful forms. Refined materials are typically sold and transferred to factories which utilize these refined materials in the creation of products which can be sold to the general public. Often times, one product requires many different kinds of materials and materials often all come from different sources, being mined from the Earth or otherwise collected or harvested. Thus, the complete supply chain for a single product, an automobile for example, can be extremely large and extensive. It is through this interconnected nature that the industrial complex of an economy grows ever larger in the face of increasing material demands by the population of a country. Raw and refined materials are also often utilized in construction of new buildings. Construction of new buildings is executed for a wide range of purposes, and each building often has its own specific purpose. For example, new structures may be residential, commercial offices, governmental offices, or new industrial facilities such as a power plant or fuel refinery.

Industrial processes such as mining, manufacturing, and construction are well known for their impact on society and the economy, however their impact upon the environment is somewhat lesser known by the general public. Unfortunately, many industrial processes have a myriad of different negative ecological impacts. It is critical that these negative impacts are minimized when these industrial processes are performed. If such impacts are not minimized, the environment can sometimes be substantially and often irreparably damaged. One particular ecological impact which is a major concern in mining and construction is surface runoff. Surface runoff is most easily described as when the in a particular area soil has become complete infiltrated by water and the water is now travelling over the surface of the ground. Surface runoff can be damaging in that the water travelling over the ground surface can cause erosion; however the most important consideration of surface runoff is what materials can become suspended and displaced by the flowing water. Surface runoff can very easily pick up soil based contaminants and then transport those contaminates to soils which were otherwise pollutant free. Water borne contaminants commonly found in surface runoff can also infiltrate water distribution systems of towns and cities, resulting in a drastic drop in the quality and purity of drinking water available to the public; in some cases the contamination is sufficient to cause potentially life threatening health problems. In addition to potentially carrying and spreading various pollutants, surface runoff often displaces large quantities of silt which can drastically disrupt aquatic environments such as a lake or river. Deposition of silt onto farmlands is also a concern as this can adversely affect the fertility of the soil used to grow crops. It is imperative that such pollution and contamination of surrounding soil be minimized or even eliminated.

The prevention of pollution and silt deposition of areas surrounding a construction zone, mining operation, or other industrial process is usually accomplished through the use of something known as a silt fence. A silt fence is essentially a type of fence which is installed surrounding an area which is producing contaminated surface runoff. Unfortunately, silt fences have been found to be of limited effectiveness in neutralizing pollutants other than silt found in surface runoff. This has lead to the development of the filter sock, which is essentially a mesh tube filled with some kind of biomass. The biomass is intended to absorb and retain various different kinds of pollutants when surface runoff passes through the filter sock. Current filter sock designs typically utilize some form of woodchips as the biomass. The use of the woodchips as the absorption biomass is not very effective and comes with several inherent disadvantages include high weight, low absorption capacity, flammability during storage, and release of heavy metals into surface runoff water. It is an object of the present invention to correct this issues by introducing a switchgrass filled filter sock. The switchgrass filled filter sock replaces the standard woodchip biomass contained within the filter sock with a switchgrass biomass that has a myriad of advantages when compared to the woodchip version. The advantages of the switchgrass biomass include, but are not limited to, increased filtering effectiveness, reduced weight, increased ease of installation, ecological neutrality, and biodegradability.

### BRIEF DESCRIPTION OF THE DRAWINGS

FIG. 1 is a perspective view of the present invention.

FIG. 2 is a perspective view of the present invention with a portion of the biodegradable filter sock cut away to reveal the botanical biomass filling within.

FIG. 3 is a basic flowchart showing how the present invention is manufactured.

FIG. 4 is a cross-sectional schematic view of the present invention depicting the functionality of the present invention.

FIG. 5 is a rear view of the present invention with a portion of the biodegradable filter sock cut away to reveal the filter biomass within.

FIG. 6 is a perspective view of a longer version of the present invention, showing the flexibility of the present invention.

### DETAILED DESCRIPTION OF THE INVENTION

All illustrations of the drawings are for the purpose of describing selected versions of the present invention and are not intended to limit the scope of the present invention.

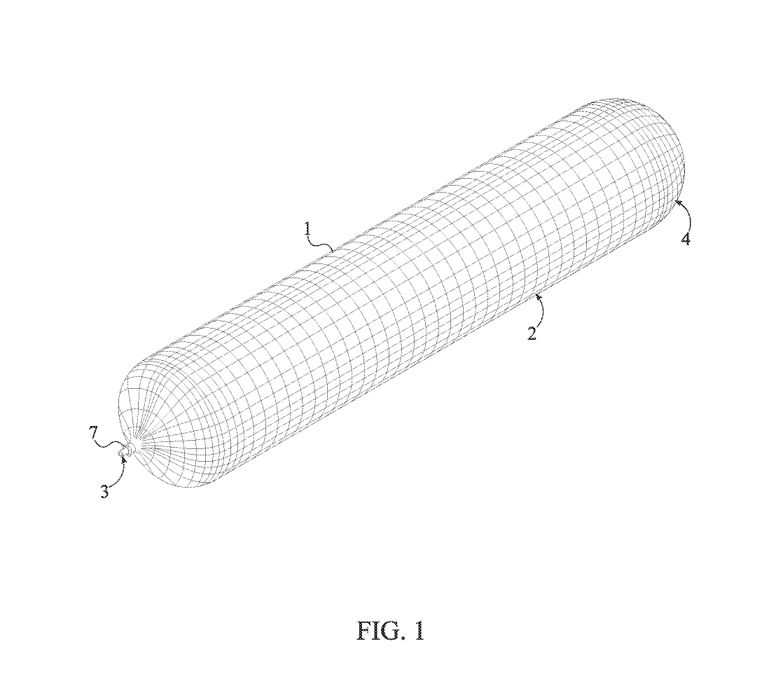

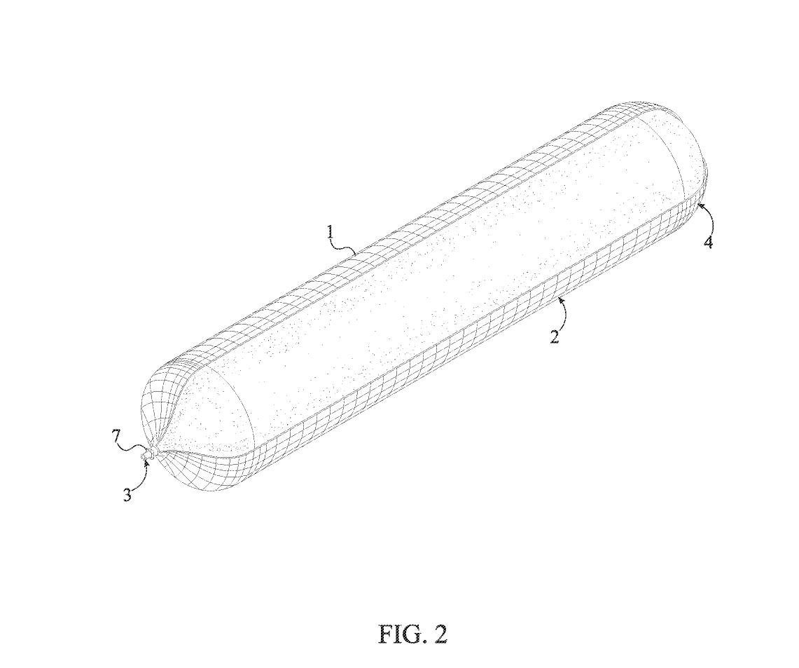

With reference to FIGS. 1-3 and FIG. 5, the present invention is a biodegradable runoff filter that serves as a silt filter and pollution neutralizing barrier which can be installed along the perimeter of an area that is known to produce polluted surface runoff. The present invention comprises a biodegradable filter sock 1, a botanical biomass filling 8, and a fastener 7. The biodegradable filter sock 1 is used to contain the botanical biomass filling 8. The biodegradable filter sock 1 is made from a biodegradable mesh that is water permeable. Specifically, the biodegradable filter sock 1 is photodegradable. This allows the user to leave the present invention in a specific location to filter runoff and eventually decay into environment friendly materials. The biodegradable filter sock 1 comprises a lateral portion 2, an open end 3, and a closed end 4. The lateral portion 2 makes up the majority of the biodegradable filter sock 1 and contains the botanical biomass filling 8. The open end 3 and the closed end 4 are positioned opposite to each other along the biodegradable filter sock 1. The open end 3 allows the user to stuff the biodegradable filter sock 1 with the botanical biomass filling 8. The botanical biomass filling 8 is positioned within the biodegradable filter sock 1 and is evenly distributed through the lateral portion 2. The botanical biomass filling 8 is used to filter contaminants from water that percolates through the biodegradable filter sock 1. The fastener 7 is used to close off the open end 3 after the biodegradable filter sock 1 has been stuffed with the botanical biomass filling 8, and thus, the open end 3 is cinched by the fastener 7. This is done to prevent the botanical biomass filling 8 from falling out of the biodegradable filter sock 1. In the preferred embodiment, the fastener 7 resembles a clip, but may alternatively resemble a tie, a clamp, or any other similar type of fastening device.

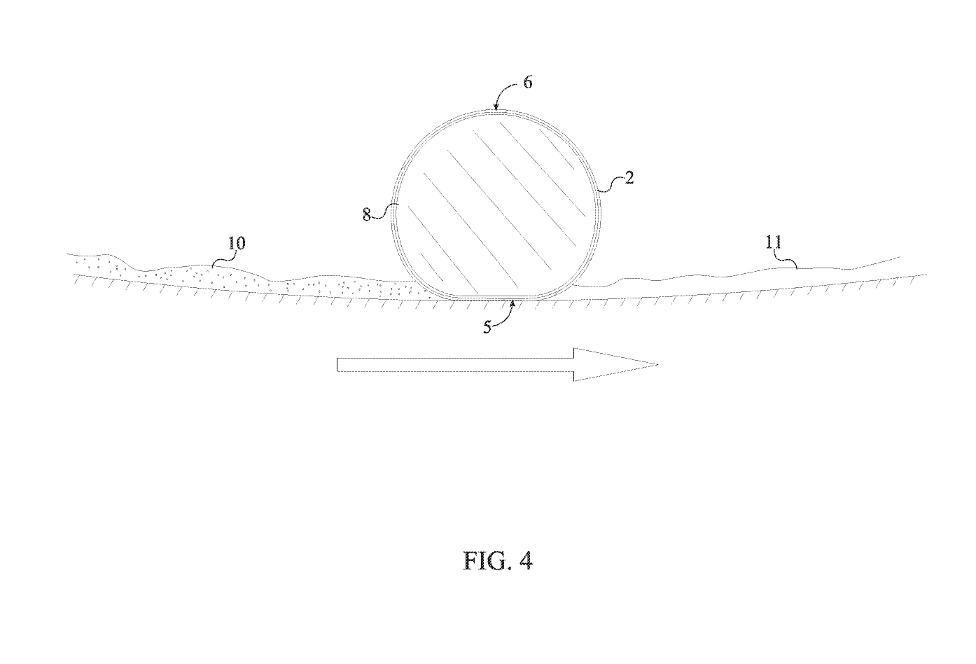

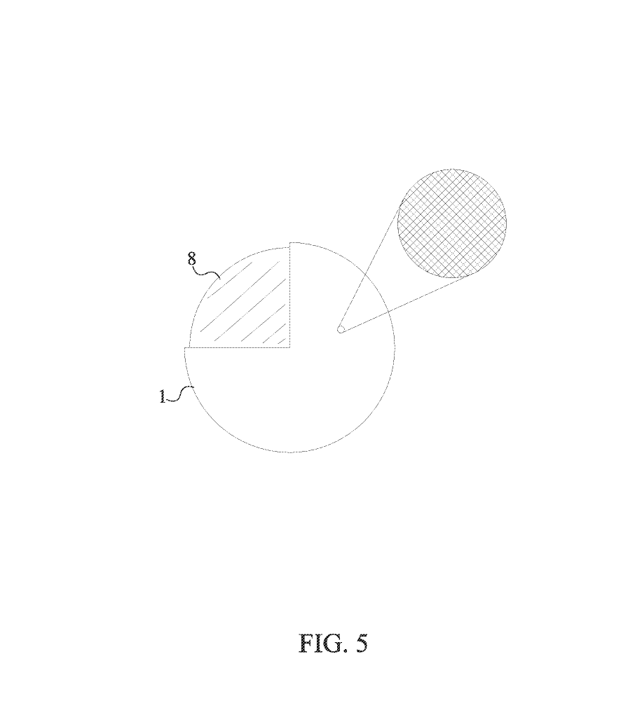

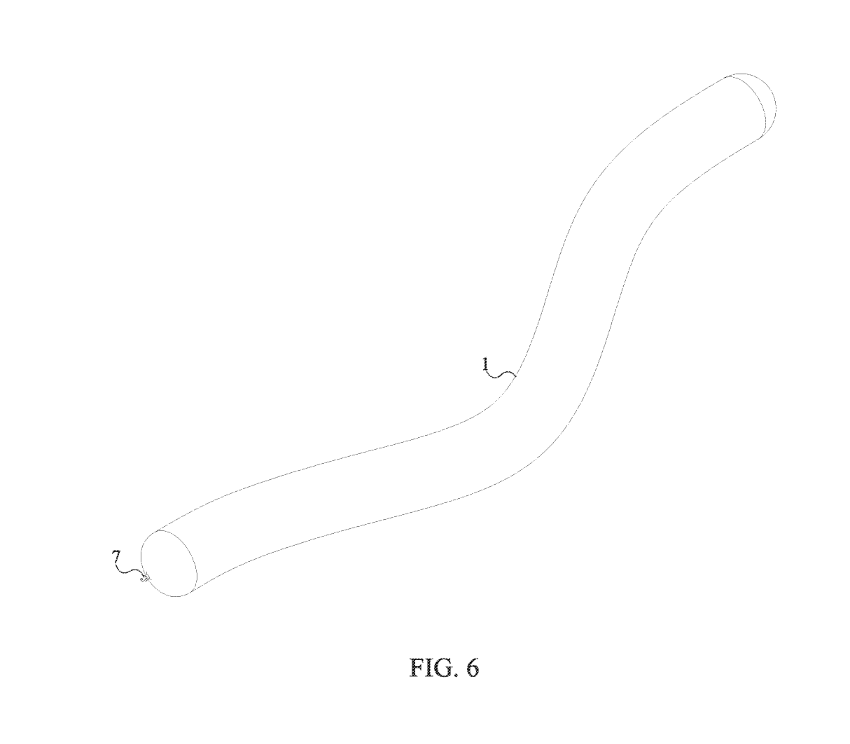

In reference to FIGS. 4-5, the lateral portion 2 comprises a deformed section 5 and an unaltered section 6. When the present invention is placed in a location where runoff needs to be filtered, the lateral portion 2 sags slightly to conform to the shape of the terrain. The deformed section 5 is the part of the lateral portion 2 that conforms to the terrain, causing water to be filtered through the entire width of the biodegradable filter sock 1, rather than a small portion of the biodegradable filter sock 1. Unfiltered water 10 enters the biodegradable filter sock 1 on one side of the lateral portion 2 and is filtered by the botanical biomass filling 8. Filtered water 11 exits through the opposite side of the lateral portion 2. The deformed section 5 also prevents the present invention from rolling or otherwise moving after the present invention has been placed in a specific location. The deformed section 5 is positioned adjacent to the unaltered section 6 about the lateral portion 2. The unaltered section 6 maintains the same general shape after the present invention has been placed on a surface. This is possible due to the structural reinforcement that the botanical biomass filling 8 provides. The existence of an unaltered section 6 is important because the unaltered section 6 allows the present invention to filter runoff with increased water levels. Because the biodegradable filter sock 1 is made from a flexible material, the present invention may be bent or maneuvered into many different shapes to adequately section off an area. This is seen in FIG. 6.

The botanical biomass filling 8 may be made from a number of different materials. Specifically, it is preferred that the botanical biomass filling 8 comprises a quantity of switchgrass. Many different species of switchgrass may be used as the botanical biomass filling 8 of the present invention, and there is no one particular option which is superior to the others. Furthermore, some mixes of several different species of switchgrass may be utilized to the same effect as a volume comprising a single species. The switchgrass is harvested and may then be further shredded into smaller pieces. The degree to which the switchgrass is shredded may vary in the final embodiment of the present invention. Once shredded, the switchgrass is packed into the biodegradable filter sock 1. The process of filling the biodegradable filter sock 1 may be completed by blowing switchgrass or other materials into the biodegradable filter sock 1. Alternatively, an auger may be used to fill the biodegradable filter sock 1. The density of the packing may vary depending upon how much force is utilized to compress the switchgrass into the biodegradable filter sock 1 when the present invention is manufactured. A denser packing of switchgrass may be more effective at filter silt and absorbing pollutants, however a more dense packing will result in a decreased water flow rate through the botanical biomass filling 8 and higher weight per unit of length of the present invention.

The use of switchgrass in the botanical biomass filling 8 of the present invention is unique and provides several key advantages when compared to the currently widespread use of woodchips as the botanical biomass filling 8 in similar apparatuses. The advantages of switchgrass over woodchips are as follows. A first advantage is the fact that the present invention has greatly reduced weight when compared to a biodegradable runoff filter that uses woodchips, as the density of the switchgrass is generally much lower than that of woodchips. Additionally, the increase filtering efficiency of the switchgrass means that even a less dense packing of the botanical biomass filling 8 is very effective. The reduced weight means that the present invention is much cheaper to transport, and is far easier to manually install. A second advantage of switchgrass is ecological neutrality. Most woodchips used in similar inventions unfortunately contain certain toxins which can leech into the ground soil when utilized as a botanical biomass filling 8; particularly heavy metals like lead, arsenic, and cadmium can be present within the woodchips. This is a serious concern, as these materials can leech into the ground soil, and will persist for very long periods of time. If livestock animals or local wildlife drink water which is contaminated with such heavy metals, said animals can easily become fatally poisoned and die. Switchgrass has been found to minimally effect to the pH of runoff water and reduce the levels of contaminants such as phosphate, tannic acid, sulfate, chloride, and Resource Conservation and Recovery Act 8 (RCRA 8) metals. Specifically, only the RCRA 8 metal, Barium, was detected in tests. In comparison to woodchips, switchgrass also results in fewer suspended and dissolved solids, fewer volatile organic compounds, and a lower turbidity after filtering.

A third advantage of switchgrass is biodegradability; in contrast, woodchips typically take a very long time to degrade, particularly when used to absorb and retain silt and sediment. In some cases, the woodchips even need to be manually removed from the site. This is not the case with the switchgrass biomass which degrades naturally and is reabsorbed by the soil. Thus, the present invention does not need to be removed manually seeing as the present invention will eventually degrade naturally. A fourth advantage of switchgrass is non-flammability; this concern relates primarily to when the present invention is manufactured. In some cases, piles of woodchips have been known to spontaneously combust. This is not the case with switchgrass, and large piles of switchgrass have not been recorded to spontaneously combust, even when in direct sunlight and exposed to high environmental temperatures. Thus, switchgrass is a much safer material to work with.

A final advantage of the switchgrass being used for the botanical biomass filling 8 is the fact that a mass of switchgrass typically allows for a greater water flow through when compared to a similar mass of woodchips. Thus, greater volumes of water are capable of flowing through the present invention and being fully filtered. This is useful as increased flow helps prevent the possibility of water pooling on one side of the biodegradable filter sock 1 and potentially causing ground erosion or spilling over the top of the biodegradable filter sock 1. Thus, switchgrass provides a superior, and more efficient material to filter out silt and sediment as well as capturing and neutralizing pollutants. Switchgrass has even been shown to have the capability to neutralize mild radioactivity, making switchgrass ideal for use in bounding mining operations which may inadvertently expose radioactive materials. The advantages listed above are the advantages of the switchgrass biomass which have been observed and recorded and make switchgrass ideal for use as the botanical biomass filling 8. It is accepted that there may be further advantages of using switchgrass which are not listed and described in this specification.

Though it is preferred that switchgrass be used in the botanical biomass filling 8, alternatively, the botanical biomass filling 8 may be made from lignocellulosic materials selected from the group consisting of: switchgrass, pine needles, corn stalks, miscanthus, and combinations thereof. Said materials and combinations thereof also provide similar advantages over woodchips and other presently used materials.

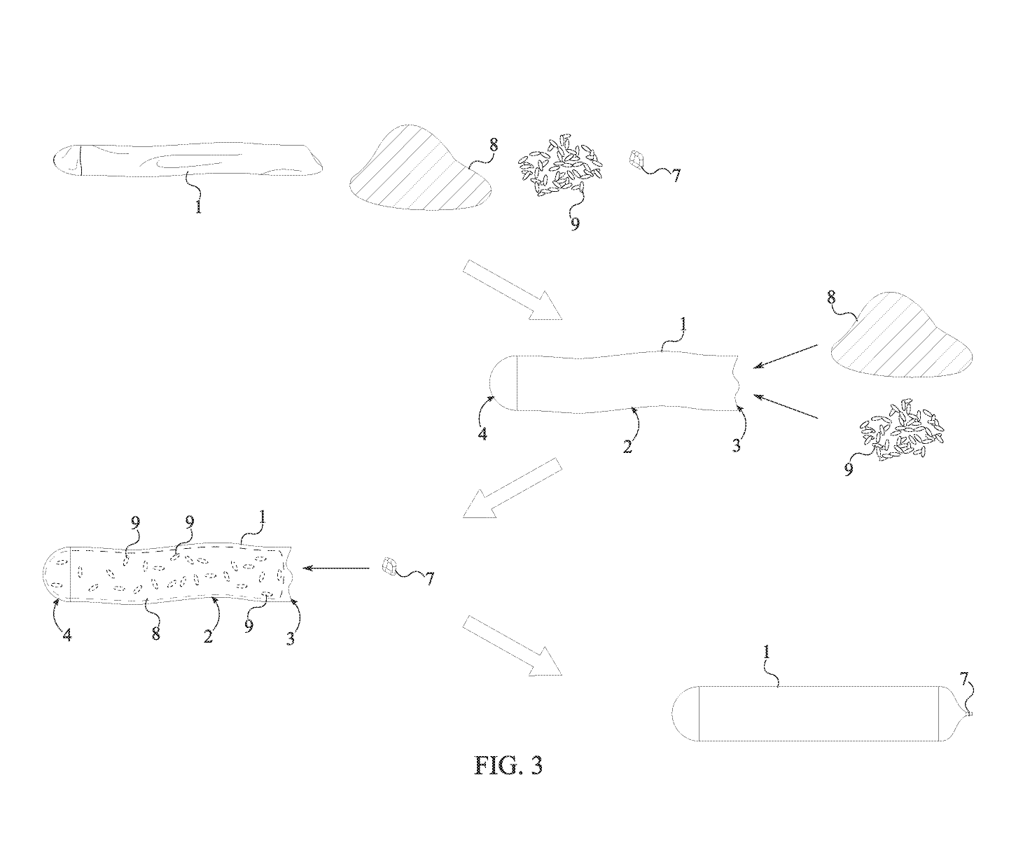

In reference to FIG. 3, in the preferred embodiment of the present invention, the biodegradable runoff filter also comprises a plurality of seeds 9. The plurality of seeds 9 are positioned within the biodegradable filter sock 1 and are distributed throughout the botanical biomass filling 8. The plurality of seeds 9 are used to promote vegetation growth. When decaying, the biodegradable filter sock 1 and the botanical biomass filling 8 supply nutrients to the surrounding soil. As a result, the plurality of seeds 9 are able to quickly grow into whatever type of plant is desired by the user. Depending on user needs, the type of seed used in the plurality of seeds 9 may vary. The plurality of seeds 9 may be used to feed livestock or wildlife, prevent erosion, repair damage done by construction, and a number of other purposes.

Although the invention has been explained in relation to its preferred embodiment, it is to be understood that many other possible modifications and variations can be made without departing from the spirit and scope of the invention as hereinafter claimed.

What is claimed is:

1. A biodegradable runoff filter comprises:
a biodegradable filter sock;
a botanical biomass filling;
a fastener;
the biodegradable filter sock comprises a lateral portion, an open end, and a closed end;
the open end and the closed end being positioned opposite to each other along the biodegradable filter sock;
the botanical biomass filling being positioned within the biodegradable filter sock;
the botanical biomass filling being evenly distributed through the lateral portion; and
the open end being cinched by the fastener.

2. The biodegradable runoff filter as claimed in claim 1 comprises:
the lateral portion comprises a deformed section and an unaltered section; and
the deformed section being positioned adjacent to the unaltered section about the lateral portion.

3. The biodegradable runoff filter as claimed in claim 1 comprises:
the botanical biomass filter being a quantity of switchgrass.

4. The biodegradable runoff filter as claimed in claim 1, wherein the botanical biomass filling being lignocellulosic materials selected from the group consisting of: switchgrass, pine needles, corn stalks, miscanthus, and combinations thereof.

5. The biodegradable runoff filter as claimed in claim 1 comprises:
a plurality of seeds;
the plurality of seeds being positioned within the biodegradable filter sock; and
the plurality of seeds being distributed throughout the botanical biomass filling.

6. The biodegradable runoff filter as claimed in claim 1 comprises:
the biodegradable filter sock being photodegradable;

7. A biodegradable runoff filter comprises:
a biodegradable filter sock;
a botanical biomass filling;
a fastener;
the biodegradable filter sock comprises a lateral portion, an open end, and a closed end;
the open end and the closed end being positioned opposite to each other along the biodegradable filter sock;
the botanical biomass filling being a quantity of switchgrass;
the botanical biomass filling being positioned within the biodegradable filter sock;
the botanical biomass filling being evenly distributed through the lateral portion; and
the open end being cinched by the fastener.

8. The biodegradable runoff filter as claimed in claim 7 comprises:
the lateral portion comprises a deformed section and an unaltered section; and
the deformed section being positioned adjacent to the unaltered section about the lateral portion.

9. The biodegradable runoff filter as claimed in claim 7, wherein the botanical biomass filling being lignocellulosic materials selected from the group consisting of: switchgrass, pine needles, corn stalks, miscanthus, and combinations thereof.

10. The biodegradable runoff filter as claimed in claim 7 comprises:
a plurality of seeds;
the plurality of seeds being positioned within the biodegradable filter sock; and
the plurality of seeds being distributed throughout the botanical biomass filling.

11. The biodegradable runoff filter as claimed in claim 7 comprises:
The biodegradable filter sock being photodegradable.

12. A biodegradable runoff filter comprises:
a biodegradable filter sock;
a botanical biomass filling;
a fastener;
the biodegradable filter sock comprises a lateral portion, an open end, and a closed end;
the open end and the closed end being positioned opposite to each other along the biodegradable filter sock;
the botanical biomass filling being lignocellulosic materials selected from the group consisting of: switchgrass, pine needles, corn stalks, miscanthus, and combinations thereof;
the botanical biomass filling being positioned within the biodegradable filter sock;
the botanical biomass filling being evenly distributed through the lateral portion; and
the open end being cinched by the fastener.

13. The biodegradable runoff filter as claimed in claim 12 comprises:
the lateral portion comprises a deformed section and an unaltered section; and
the deformed section being positioned adjacent to the unaltered section about the lateral portion.

14. The biodegradable runoff filter as claimed in claim 12 comprises:
the botanical biomass filter being a quantity of switchgrass.

15. The biodegradable runoff filter as claimed in claim 12 comprises:
a plurality of seeds;
the plurality of seeds being positioned within the biodegradable filter sock; and
the plurality of seeds being distributed throughout the botanical biomass filling.

16. The biodegradable runoff filter as claimed in claim 12 comprises:
The biodegradable filter sock being photodegradable.
